(19) United States
(12) Patent Application Publication
(10) Pub. No.: US 2012/0177130 A1
(43) Pub. Date: Jul. 12, 2012

(54) VIDEO STREAM PRESENTATION SYSTEM AND PROTOCOL

(75) Inventors: Isaac Levy, New York, NY (US); Tal Shalom, Fair Lawn, NJ (US); Meir Sela, Cresskill, NJ (US); Stephan Wenger, Hillsborough, CA (US)

(73) Assignee: Delta Vidyo Inc., Hackensack, NJ (US)

(21) Appl. No.: 13/303,539

(22) Filed: Nov. 23, 2011

Related U.S. Application Data
(60) Provisional application No. 61/421,918, filed on Dec. 10, 2010.

(51) Int. Cl. H04N 7/26

(52) U.S. Cl. 375/240.25; 375/E07.027

(57) ABSTRACT

Disclosed are techniques for a system and protocol that provides for composition of a video scene that embeds one or more video sequences into a background image. The protocol enables a video stream presentation system (e.g., IPTV) to automate the embedding by one or more decoders of video sequence content and non-background information, for example, stock tickers, close caption, or date/time information, into a background.

### CROSS REFERENCE TO RELATED APPLICATIONS

The application claims the benefit of priority from U.S. Provisional Application Ser. No. 61/421,918, filed Dec. 10, 2010, which is hereby incorporated by reference herein in its entirety.

### FIELD

This application relates to television (TV) show production. More specifically, the application relates to the composition of a video scene that embeds one or more video sequences into a static background image.

### BACKGROUND

Subject matter related to the present application can be found in co-pending U.S. patent application Ser. No. 12/971,650, filed Dec. 17, 2010 and entitled “System And Method For Interactive Synchronized Video Watching”, and co-pending U.S. patent application Ser. No. 12/765,793, filed Apr. 22, 2010 and entitled “Systems, Methods and Computer Readable Media for Instant Multi-Channel Video Content Browsing in Digital Video Distribution Systems,” which are hereby incorporated by reference herein in their entireties.

The mixing of still image and video content in TV production is traditionally performed in a device known as a “video mixer.” An article by Mike Krin entitled “The Panel Is In: An Operator's View of the Ideal User Interface”, Video Systems Magazine, April 1995, also available at http://www.nonlinear.info/krim.htm, contains a description of the user interfaces for the insertion of video content into background, and advocates the use of a complex, expensive (tens of thousands of dollars) and unintuitive (at least for the beginner) user interface based on a video switcher panel for the insertion process. The use of such equipment is still common in studios today. These tools can work in real-time settings, i.e., in live TV production.

Video cutting software, such as Adobe Premiere, also allows for the insertion of video material into a background. However, such software does not allow operation in real-time.

What the background art systems, including the two described above, have in common is that the assembly of pixels from still images and video sequence images is performed not at the decoder, but at the producing end of the distribution chain, i.e., before the encoding of the assembled video sequence.

### SUMMARY

Disclosed are techniques for a system and protocol that provides for composition of a video scene that embeds one or more video sequences into a background image. The protocol enables a video stream presentation system to automate the embedding by one or more decoders of video sequence content and non-background information, for example, stock tickers, close captions, or date/time information, into a background.

Certain embodiments utilize a “background image,” which, in some embodiments, is a computer-readable image at a resolution sufficiently high to allow for reproduction on a TV screen. A TV producer can mark areas of the background image in which video sequences or stock ticker information is to be displayed. The producer can further include information related to the video sequences. Any of these activities can result in a “layout.” The marking can be performed through use of a color, alpha channel information in the picture data, or any other form of pixel-based machine-interpretable representation of information. The layout can be uploaded to an application server using, for example, a file transfer mechanism. At video production time, the producer can request the layout, for example from the application server. A producer console can instruct, for example, a Scalable Video Coding Switch (SVCS) or other digital video source, to stream video(s) to be embedded in the layout to one or more decoders and can also distribute the layout to the one or more decoders. The decoders can render that layout with embedded video on a video output.

### BRIEF DESCRIPTION OF THE DRAWINGS

FIG. 1 is a block diagram illustrating an exemplary video stream presentation system in accordance with an embodiment of the disclosed subject matter.

FIG. 2 is an exemplary screenshot of a user's screen, generated in accordance with an embodiment of the disclosed subject matter.

FIG. 3 is an example of an exemplary layout in accordance with an embodiment of the disclosed subject matter.

FIG. 4 is an exemplary activity and message sequencing chart in accordance with an embodiment of the disclosed subject matter.

FIG. 5 is a screenshot of an exemplary producer's console in accordance with an embodiment of the disclosed subject matter.

FIG. 6 is a flowchart outlining an exemplary upload in accordance with an embodiment of the disclosed subject matter.

FIG. 7 is a computer system for use with exemplary embodiments of the disclosed subject matter.

Throughout the drawings, unless otherwise stated, the same reference numerals and characters are used to denote like features, elements, components or portions of the illustrated embodiments. Moreover, while the disclosed subject matter will now be described in detail with reference to the figures, it is done so in connection with the illustrative embodiments.

### DETAILED DESCRIPTION

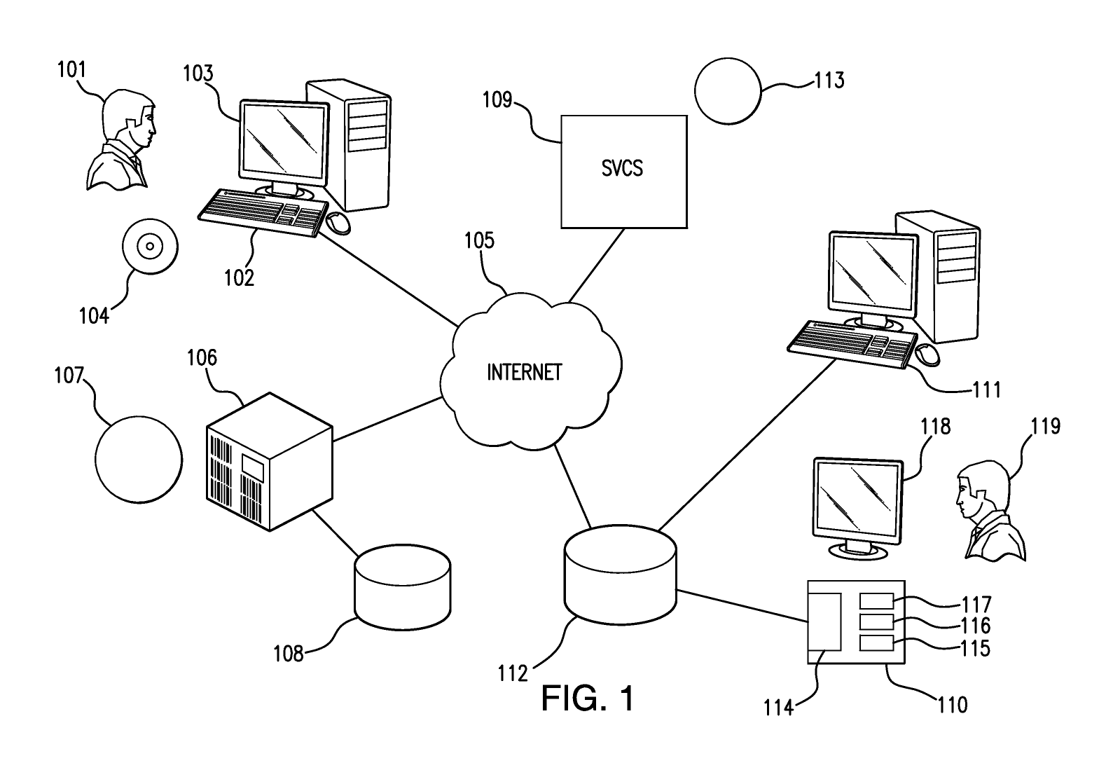

FIG. 1 depicts the layout of an exemplary video stream presentation system according to an embodiment of the disclosed subject matter. A human producer 101 operates a producer console, which may be in the form of a PC 102 with a high resolution display 103 and other commonly found I/O devices such as keyboard, mouse, speakers, microphone (not shown). The producer console can require a program to operate in the fashion presented below, and such a program can be stored on a computer readable medium 104. The producer console can be connected to a suitable network 105 such as the Internet or a private IP network.

Also connected to the network 105 can be an application server 106. The application server 106 can be a physical server or a virtual server, and can call a program, which can be stored on a computer readable medium 107. The application server 106 can be connected (directly or via the network 105), or can include a database 108 for information such as video sequences, configuration information, layouts (defined below) and so on.

Also connected to the network 105 can be at least one SVCS 109, as disclosed, for example, in co-pending U.S. patent application Ser. No. 12/971,650. The relevant SVCS functionality is to forward—optionally after protocol conversion—commands or statuses that have been issued by the application server 106 or the decoder(s) 110, 111, by using the network 105 for data transmission. Further, in some embodiments the SVCS forwards (SVC-coded) video from a video database 112 or any other accessible source (not depicted) to one or more decoders 110, 111. The SVCS 109 can operate on a physical or virtual server, and can call a program stored on a computer readable medium 113.

Also connected to the network can be at least one decoder 110, 111, which can include at least a network interface 114, a video decoder 115, a background presenter 116, and a renderer 117. The video decoder 115 can decode one or more suitably coded video sequences arriving from the network interface 114 using, for example, a streaming protocol, and can make the video sequences available in the form of image sequences to the renderer 117. The background presenter 116 can provide the renderer 117 with an image of a background image in pixel form. One example of a background presenter 116 is a web browser. Examples of the renderer 117 include the Graphical User Interface functionality of Windows or an X-Server. The renderer 117, with assistance of hardware such as a graphics interface and a screen 118, can make, directly or indirectly, i.e., through a distribution system such as cable TV, the images and videos visible to a user 119 (only the “direct” availability is shown in FIG. 1).

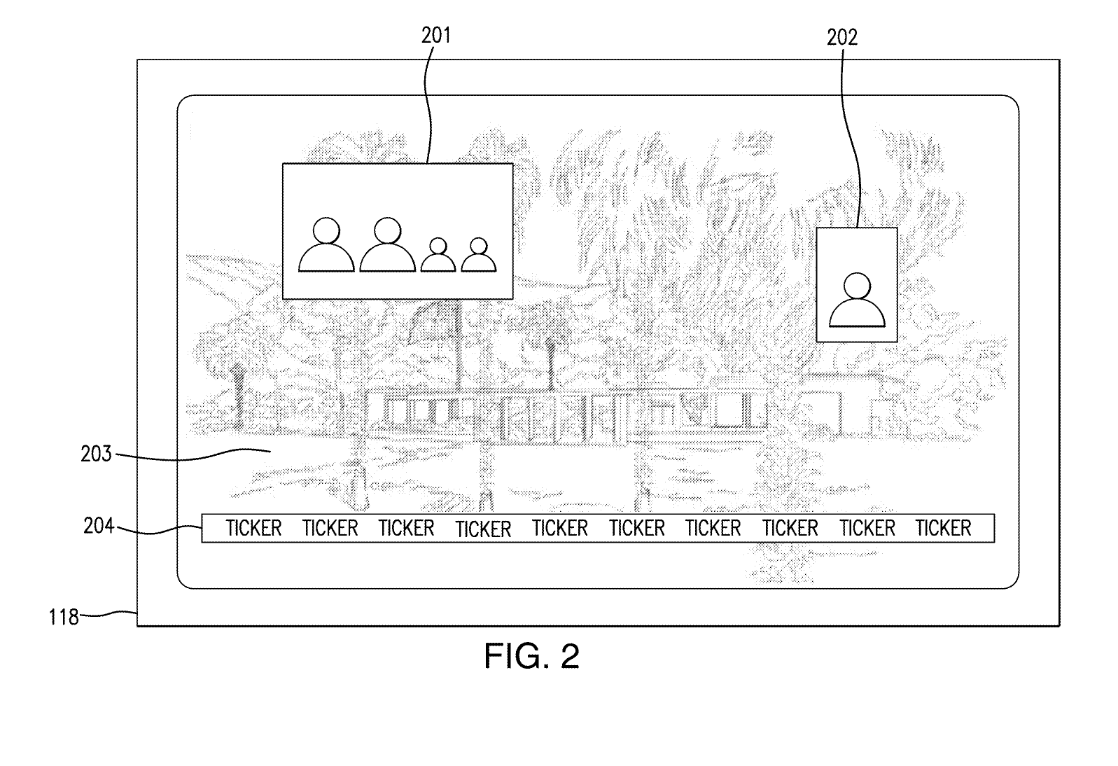

FIG. 2 presents the user-perceived view of an exemplary screen layout enabled by an embodiment of the disclosed subject matter. Two video sequences 201, 202, of different size, orientation, and location are embedded into a static background 203, which can fill the whole screen 118. There can also be one or more crawlers 204 included in the screen layout. The crawler 204 includes other types of non-background, non-static information that is typically updated or played back, such as such as a stock ticker, sport results, close caption information, progress bars, and date/time, but other non-static information can be displayed.

In exemplary embodiments, the video sequence content 201, 202 and the crawler 204 are automatically inserted into a background 203. In order to use the disclosed subject matter, the background may be prepared in an artistic process by a human operator, such as the producer. The creation of the background is not subject to the disclosed subject matter, but the background has to fulfill a number of criteria to be useful in the disclosed subject matter.

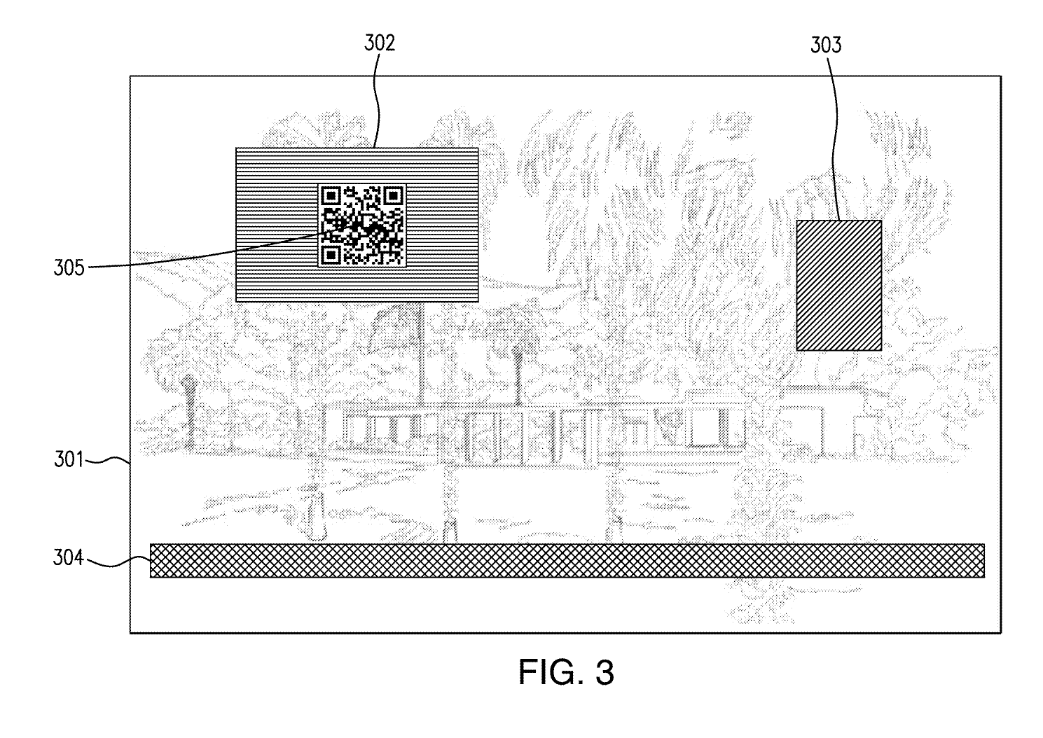

FIG. 3 depicts a background used in an embodiment of the disclosed subject matter. In some embodiments, the starting point in the creation of the background is a computer-readable image 301 in a resolution sufficiently high to look pleasing when reproduced on a TV screen. Preferably, the background is in the native resolution of the intended final format of the production, for example, 720p (1280×720). If the background is in a higher or lower resolution, the producer console can scale the background to the native resolution using one of the many scaling technologies known to those skilled in the art. The background can be a scene captured, for example, by a still image camera, artificially created using tools such as Photoshop, or a hybrid. In a certain embodiment, the producer marks the area(s) 302, 303, 304 in which video sequences and/or crawlers are to be presented in a suitable format.

In the same or another embodiment of the disclosed subject matter, a marking can be the use of at least one color, expressed in pixel values in a color space. In FIG. 3, the color information is substituted by different fill patterns.

In the same or another embodiment, if the image storage format supports such, the marking can be implemented by using alpha channel information in the picture data.

In the same or another embodiment, the marked area(s) can include information related to the video sequence that can be inserted later in the process. This information can be coded in a suitable format, such as a two dimensional bar code 305. Shown as an example is a URL (to http://www.example.com) codified in QR code. However, any other form of pixel-based, machine-interpretable representation of information can also be used. A person skilled in the art can readily create information in QR code or similar formats by using one of the many Internet-based code generators, and inserting the resulting image into the marked area using a tool, such as Photoshop.

The background image with the marked areas is henceforth referred to as the “layout.”

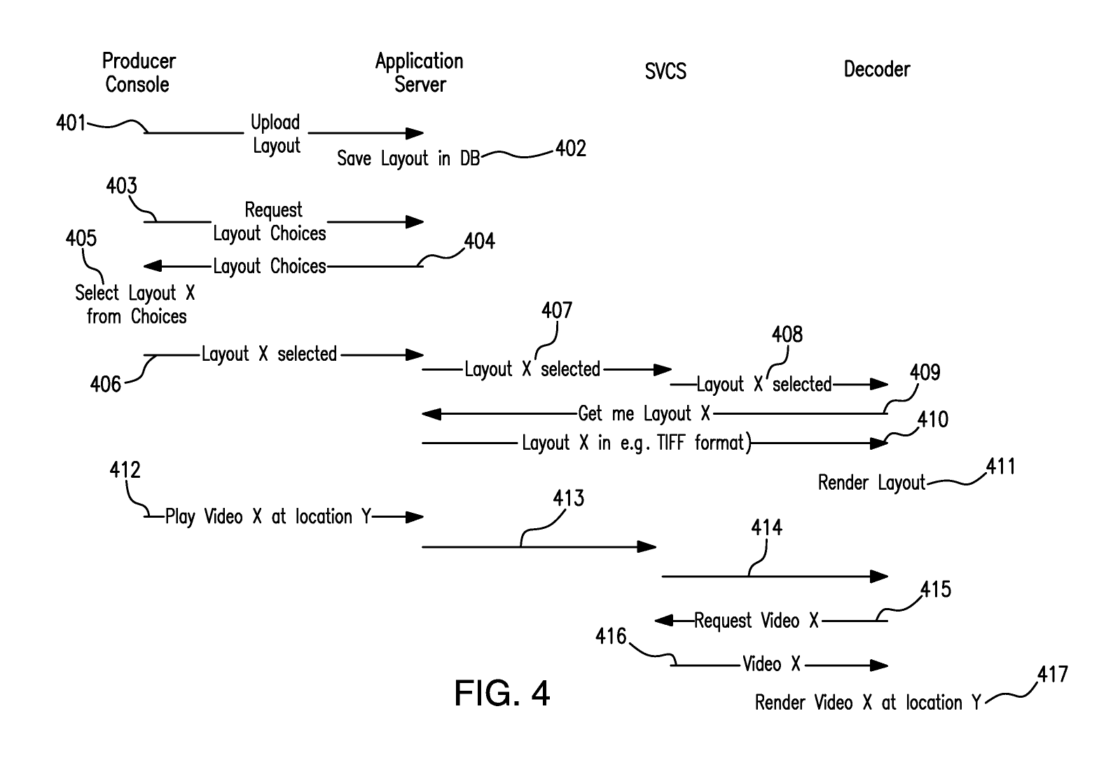

FIG. 4 illustrates an exemplary message and activity sequencing chart, informally known as a “ladder diagram” of the mechanisms used in the same or another embodiment of the disclosed subject matter. In order to use a layout that has been created as described above, according to one embodiment, the producer can upload 401 the layout to an application server by, for example, instructing the producer console to do so. The uploading process can employ a file transfer mechanism, such as FTP. The application server can save 402 the layout in a database for future reference. The uploading process can further include an extraction and transmission of the coordinates for the video window(s), as discussed below. The layout, and the coordinates for the video windows, are now available for future use and do not need to be recreated by the producer again.

Once the producer is ready to produce a video using a layout according to the disclosed subject matter, he/she can request 403 layout choices from the application server. The application server can respond 404 with a list of available layouts, in textual, graphic, or any other suitable form. The producer can select 405 the appropriate layout for this session, for example by selecting it with a mouse click, and can send 406 this selection to the application server. There are many alternative ways to implement this mechanism that will be known to those skilled in the art.

As one alternative, according to an embodiment of the disclosed subject matter, the application server creates a web page, wherein each available layout is listed in the form of a hyperlink. When clicking on the link, the web browser conveys this link (for example, through steps such as those implemented in a web server, which not depicted) to the application server. By using information in the link, the application server can identify the previously uploaded layout.

In one embodiment of the disclosed subject matter, upon selection of a layout, the application server can send 407 a command to the SVCS instructing that the selected layout is to be used. The SVCS, upon receipt of this command, can issue 408 a command to one or more decoder(s) to use the layout as well.

Briefly returning to FIG. 1, the motivation for the involvement of the SVCS in this process can be as follows. In one embodiment of the disclosed subject matter, the SVCS 109 can be the only instance that is aware of the number, and addresses, of the decoder(s) 110, 111, while the application server 106 is aware of the address of the SVCS 109, but not of the decoders served by the SVCS 109. The SVCS 109, therefore, “hides” the nature of the decoder population 110, 111 from the application server 106.

Returning to FIG. 4, the decoder reacts to the reception of this command by downloading the layout from the resource that is part of the command, which can be a location in the application server's database, or a location anywhere on the Internet or other suitable network (not shown). This can involve a request 409 to the resource where the layout is located, and the resource can respond 410 with the layout. Once the layout has been received, the decoder can render 411 it on its video output and/or display on a screen. In the same or another embodiment, this is implemented by using the layout as the background image of the web browser that runs on the decoder's user interface. The layout is now visible by the decoder's user.

In the same or another embodiment of the disclosed subject matter, the producer can select the video sequences he/she wants to be embedded into the layout, before, simultaneously, or after this transmission of the layout. This selection process can have different forms:

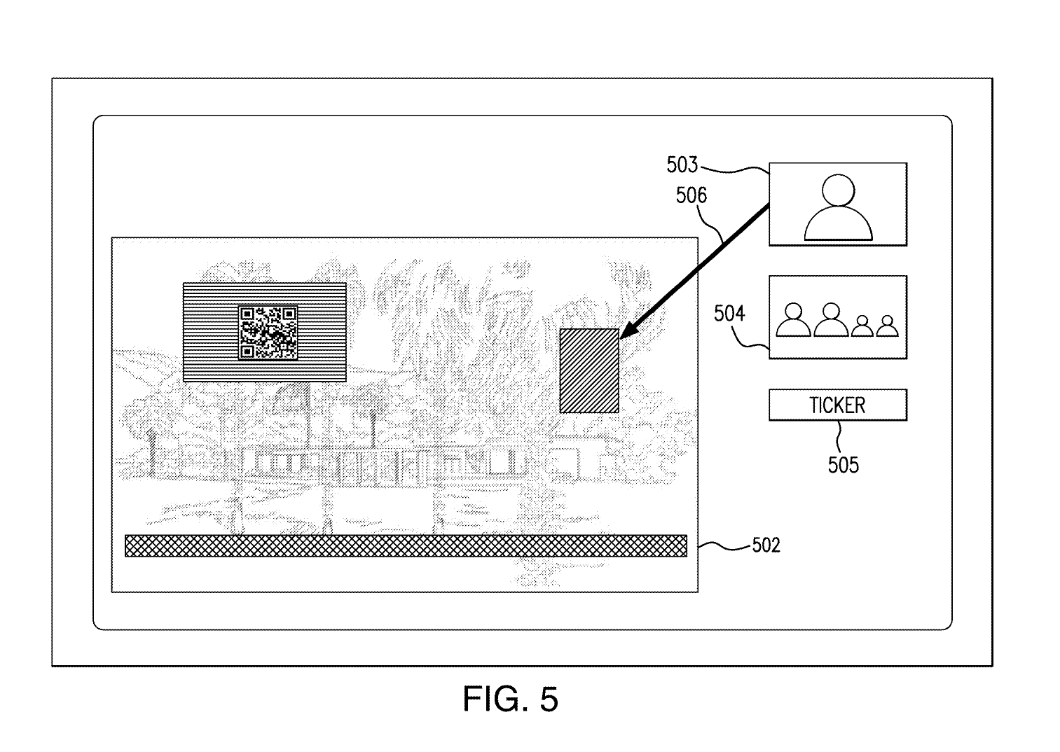

In one embodiment, the producer can have a list, icons, or mini browsing windows (MBWs) of video sequences on his/her screen, along with the layout and other information. In order to allow for that, the producer's video screen can have a higher resolution than the resolution the decoder is running. Briefly referring to FIG. 5, depicted is an exemplary screen shot of the producer's console 501. Shown is the layout 502, mini browsing windows 503, 504 for one or more (here: two) video sequences, a crawler 505, and so on. The producer can drag-and-drop 506 a mini browsing window 503 into one of the windows of the layout (that are color coded, depicted in FIG. 5 through shading), thereby “inserting” the video sequence into the layout. It should be understood that, according to the disclosed subject matter, “inserting” does not imply an embedding of the video bits representing the video content into the still image bits representing the background, nor does it imply the insertion of metadata related to the video bits (with the exception of the aforementioned barcode).

In the same or another embodiment, the windows in the layout can be pre-populated by information in the layout, coded, for example, in the form of a barcode representing a hyperlink as introduced previously. In this case, the producer can accept the default selection or, alternatively, can override it by dragging-and-dropping 506 a mini browsing window 503 representing a different video sequence into a window in the layout.

Returning to FIG. 4, in the same or another embodiment, any of such actions can result in the producer console sending 412 a command to the application server to play the identified sequence and display the sequence at a position and resolution as indicated by the color coding of the layout, and that has been extracted during the step of uploading 401. The application server, after reception of the command, issues its own command through the SVCS 413 to the decoder(s) 414, as already discussed, containing at least parts of the aforementioned information. The decoder can use the information to request 415 (through mechanisms not relevant to this disclosed subject matter, but disclosed, for example in co-pending U.S. patent application Ser. No. 12/765,793) a streaming of a bitstream representing the video sequence. Once the streaming has commenced the decoder can decode 416 the bits of the video sequence and render them at the window reserved for that sequence based on the information received 417.

One distinguishing aspect of the disclosed subject matter relative to Prior Art is that the “mixing” of video and background content on a pixel level occurs at the decoder(s), and not at the producer console.

This mechanism can be exercised as necessary to populate all windows in the layout. The streaming format can vary based on the property of the window. For example, in the same or another embodiment, a window for a video sequence can use an SVC coded video stream, whereas a window for a crawler can use an RFC 4396 coded textual message.

In the same or another embodiment, the decoder does not start rendering the layout and the video sequences that have been already started to stream until it receives a “render” command.

In order to know the appropriate time for the render command, the application server needs to know whether the decoder has received at least the initial streaming pictures to be able to display meaningful information in all its windows. Therefore, in the same or another embodiment, the decoder can report, through the SVCS to the application server, whenever it has received such meaningful information for a given window or for all windows. This information can be used to inform the producer that the decoder is “up” in the sense that all information the producer wishes to render is now being rendered.

In the same or another embodiment, the producer can also issue a “stop render” command. This command is forwarded as already described from the application server through the SVCS to the decoder(s), which, upon reception, stop(s) rendering.

The step of uploading a layout to the application server 401 shall be described in more detail. It has already been mentioned that during this step, the producer console extracts the coordinates of video windows from the background image to create the metadata associated with the layout.

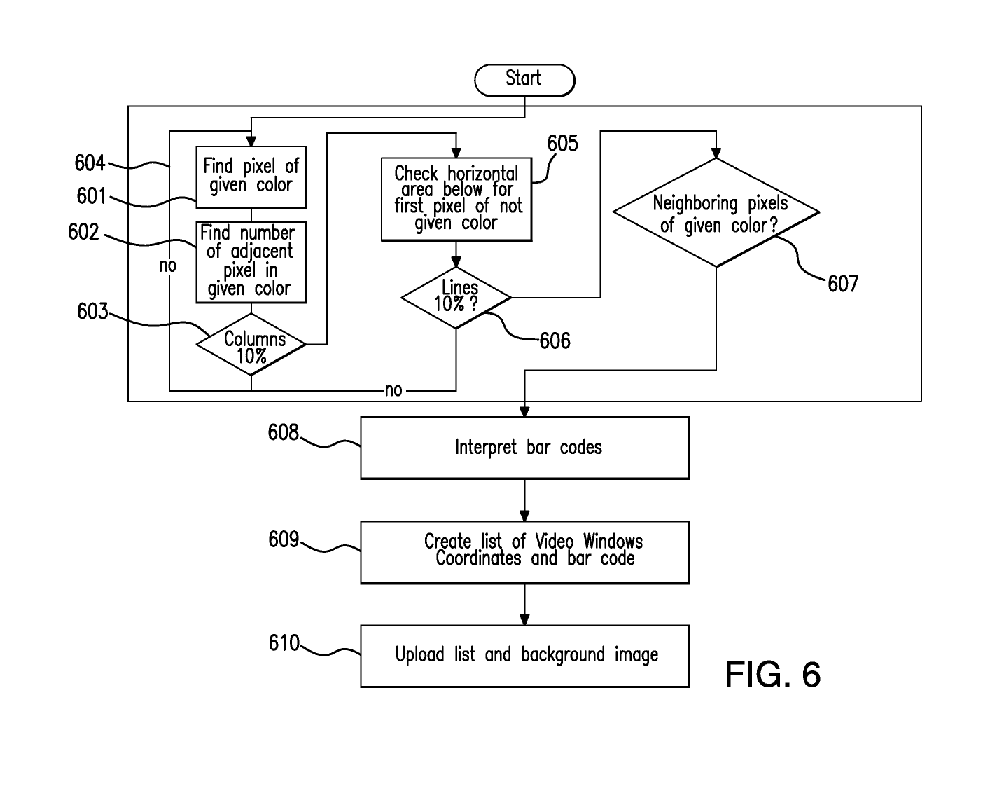

Referring to FIG. 6, in one embodiment of the disclosed subject matter, the video windows must be perfect rectangles. A “perfect rectangle” is defined herein as a rectangular array of pixels fulfilling the following properties:
1) all pixels are of the same given color (i.e., the same sample values for all pixels in the rectangle) or, when a bar code is used, in two different colors;
2) the width and height are at least 10% of the width and height of the background image; and
3) there are no pixels of the same given color directly adjacent to the rectangle.

Defining a rectangle this way assures that a search mechanism going through the background data does not find irregularly shaped, or too small, areas, which would not be a fit for a video window.

A search mechanism to find a perfect rectangle can operate according to the following outline.

First, the background image is searched 601, line by line and column by column, for a pixel of the given color (or two different colors). The “given color” henceforth includes the color that is used to mark the rectangle, and the color that can be used for placing a barcode into the rectangle. Once such a pixel is found, the remainder of the current line is searched 602 for adjacent pixels of the given color. If the number of adjacent pixels of the given color is at least 10% of the number of pixels in the line, then a candidate for a video window—namely a potential first line of the video window—has been found 603. Otherwise, the process restarts 604 at the next pixel in scan order.

In order to determine the vertical size of the video window, for the lines “below” the line just found, at the same horizontal positions, it is checked 605 that the pixels are of the given color. Once a pixel is found that is not of the given color, the vertical size of the video window has been identified.

It is then checked 606 whether the potential video window extends vertically to span at least 10% of the background image area.

Finally, all pixels adjacent to the identified video window are checked 607 that they are not of the given color. If one or more of these pixels is of the given color, no perfect rectangle has been found; the identified area is not considered a video window, and the process for search continues.

The process continues until the whole area of the screen has been scanned for video windows (as there can be more than one).

Once at least one perfect rectangle has been found, the following steps can be executed:
the bar code, if any, can be interpreted 608; and
the coordinates of the video window, along with the information of the bar code (which can be a Unified Resource Identifier, URI) can be placed 609 in a list of found video windows.

Uploaded 610 to the application server is the layout, which can include:
the pixel data of the background image, coded in a suitable format (including, for example, TIFF, PNG, PEG); and
the list of video window coordinates and associated pre-configured content, if any (as found in the barcode).

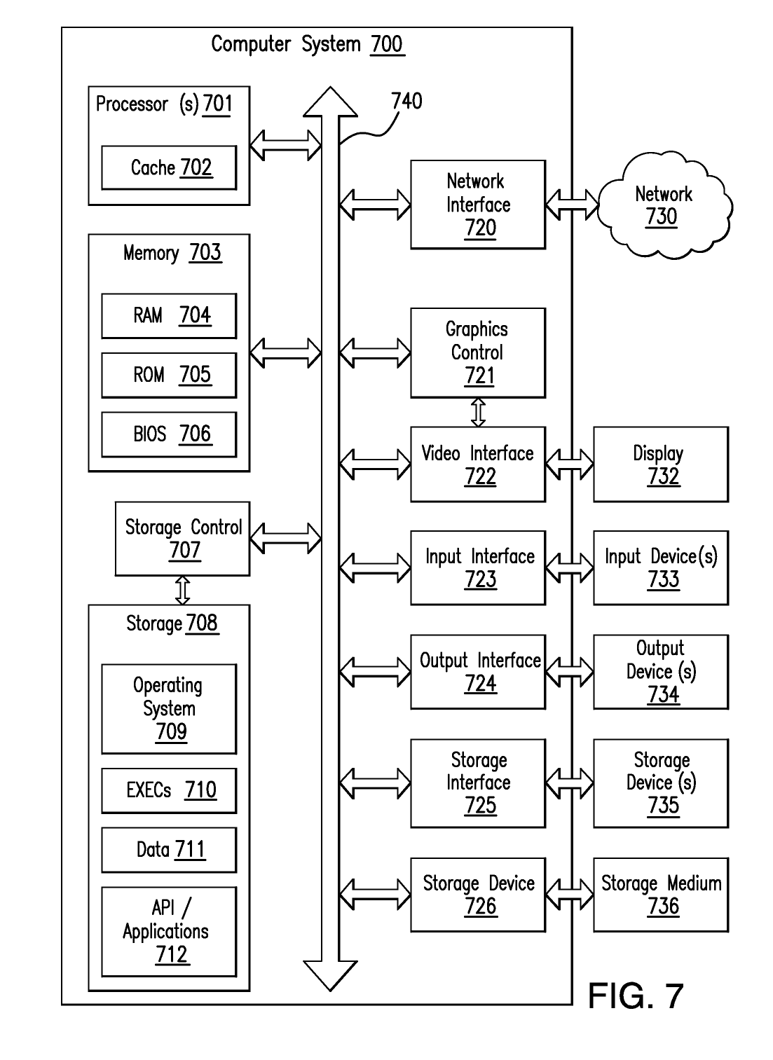

The methods for composition of a video scene that embeds one or more video sequences into a background image, described above, can be implemented as computer software using computer-readable instructions and physically stored in computer-readable medium. The computer software can be encoded using any suitable computer languages. The software instructions can be executed on various types of computers. For example, FIG. 7 illustrates a computer system 700 suitable for implementing embodiments of the present disclosure.

The components shown in FIG. 7 for computer system 700 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 700 can have many physical forms including an integrated circuit, a printed circuit board, a small handheld device (such as a mobile telephone or PDA), a personal computer or a super computer.

Computer system 700 includes a display 732, one or more input devices 733 (e.g., keypad, keyboard, mouse, stylus, etc.), one or more output devices 734 (e.g., speaker), one or more storage devices 735, various types of storage medium 736.

The system bus 740 link a wide variety of subsystems. As understood by those skilled in the art, a “bus” refers to a plurality of digital signal lines serving a common function. The system bus 740 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 701 (also referred to as central processing units, or CPUs) optionally contain a cache memory unit 702 for temporary local storage of instructions, data, or computer addresses. Processor(s) 701 are coupled to storage devices including memory 703. Memory 703 includes random access memory (RAM) 704, read-only memory (ROM) 705, and a basic input/output system (BIOS) 706. As is well known in the art, ROM 705 acts to transfer data and instructions uni-directionally to the processor(s) 701, and RAM 704 is used typically to transfer data and instructions in a bi-directional manner. Both of these types of memories can include any suitable of the computer-readable media described below.

A fixed storage 708 is also coupled bi-directionally to the processor(s) 701, optionally via a storage control unit 707. It provides additional data storage capacity and can also include any of the computer-readable media described below. Storage 708 can be used to store operating system 709, EXECs 710, data 711, application programs 712, and the like and is typically a secondary storage medium (such as a hard disk) that is slower than primary storage. It should be appreciated that the information retained within storage 708, can, in appropriate cases, be incorporated in standard fashion as virtual memory in memory 703.

Processor(s) 701 is also coupled to a variety of interfaces such as graphics control 721, video interface 722, input interface 723, output interface 724, storage interface 725, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 701 can be coupled to another computer or telecommunications network 730 using network interface 720. With such a network interface 720, it is contemplated that the CPU 701 might receive information from the network 730, or might output information to the network in the course of performing the above-described method. Furthermore, method embodiments of the present disclosure can execute solely upon CPU 701 or can execute over a network 730 such as the Internet in conjunction with a remote CPU 701 that shares a portion of the processing.

According to various embodiments, when in a network environment, i.e., when computer system 700 is connected to network 730, computer system 700 can communicate with other devices that are also connected to network 730. Communications can be sent to and from computer system 700 via network interface 720. For example, incoming communications, such as a request or a response from another device, in the form of one or more packets, can be received from network 730 at network interface 720 and stored in selected sections in memory 703 for processing. Outgoing communications, such as a request or a response to another device, again in the form of one or more packets, can also be stored in selected sections in memory 703 and sent out to network 730 at network interface 720. Processor(s) 701 can access these communication packets stored in memory 703 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 700 can provide functionality as a result of processor(s) 701 executing software embodied in one or more tangible, computer-readable media, such as memory 703. The software implementing various embodiments of the present disclosure can be stored in memory 703 and executed by processor(s) 701. A computer-readable medium can include one or more memory devices, according to particular needs. Memory 703 can read the software from one or more other computer-readable media, such as mass storage device(s) 735 or from one or more other sources via communication interface. The software can cause processor(s) 701 to execute particular processes or particular parts of particular processes described herein, including defining data structures stored in memory 703 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The foregoing merely illustrates the principles of the disclosed subject matter. While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosed subject matter and are thus within the spirit and scope thereof.

What is claimed is:

1. A method of video presentation at a decoder, comprising:
receiving a layout including at least one marked area;
receiving and decoding at least one picture of at least one video sequence or crawler; and
rendering at the decoder the at least one received and decoded picture by replacing the pixels of the marked area with the received and decoded picture.

2. The method of claim 1, wherein the marked area is marked by at least one of an alpha channel, a color, and a texture.

3. The method of claim 1, wherein the marked area contains information related to a video sequence.

4. The method of claim 3, wherein the information related to a video sequence comprises a bar code.

5. The method of claim 1, wherein the layout is received from an application server.

6. The method of claim 5, wherein the layout is received from the application server using an SVCS.

7. The method of claim 1, wherein the at least one video sequence or crawler is received using an SVCS.

8. The method of claim 1, wherein the receiving and decoding comprises receiving and decoding at least one picture of the crawler, the crawler including at least one of: a stock ticker, sport results, close caption information, progress bars, day of the week, calendar date, and time of day.

9. A non-transitory computer-readable medium having a set of instructions programmed to perform the methods of one of claims 1-8.

10. A system for presenting video at a decoder, the system including:
a decoder configured to:
receive a layout, wherein the layout includes at least one marked area;
receive and decode at least one picture of at least one video sequence or crawler; and
render the at least one received and decoded picture by replacing the pixels of the marked area with the decoded picture.

11. The system of claim 10, wherein the marked area is marked by at least one of an alpha channel, a color, and a texture.

12. The system of claim 10, wherein the marked area contains information related to a video sequence.

13. The system of claim 12, wherein the information related to a video sequence is in the form of a bar code.

14. The system of claim 10, further comprising:
an application server, in communication with the decoder, wherein the layout is obtained from the application server.

15. The system of claim 10, further comprising an SVCS, in communication with the decoder, wherein the decoder is further configured to receive the layout from the application server using the SVCS.

16. The system of claim 10, further comprising an SVCS, in communication with the decoder, wherein the at least one picture of at least one video sequence or crawler is received by the decoder using an SVCS.

17. The system of claim 10, wherein at least one video sequence or crawler comprises at least one crawler, wherein the crawler includes at least one of: a stock ticker, sport results, close caption information, progress bars, day of the week, calendar date, and time of day.
